(19) United States
(12) Patent Application Publication
(10) Pub. No.: US 2008/0241642 A1
(43) Pub. Date: Oct. 2, 2008

(54) ELECTROCHEMICAL OXIDATION OF FORMIC ACID USING A NOBLE METAL BASED CATALYST WITH ADMETALS

(76) Inventors: Coca Iordache, Vancouver (CA); Sharon Blair, Coquitlam (CA); Derek Lycke, Vancouver (CA); Sean Huff, Coquitlam (CA)

Correspondence Address: MCANDREWS HELD & MALLOY, LTD, 500 WEST MADISON STREET, SUITE 3400, CHICAGO, IL, 60661, US

(21) Appl. No.: 11/965,890

(22) Filed: Dec. 28, 2007

Related U.S. Application Data
(60) Provisional application No. 60/877,916, filed on Dec. 29, 2006.

(51) Int. Cl. H01M 4/90; B01J 23/22; B01J 23/28; B01J 23/42; B01J 23/44; B01J 23/46; B01J 23/52; H01M 4/92; B01J 23/644; B01J 23/648; B01J 23/652; B01J 23/68; B01J 21/18

(52) U.S. Cl. 429/44; 502/300; 502/339; 502/325; 502/182; 502/344; 502/352; 502/330; 502/353; 502/310; 502/312; 502/311; 502/313; 502/321; 502/308; 502/349; 429/40; 502/101

(57) ABSTRACT

A catalyst formulation for an organic fuel cell includes a noble metal and an admetal. The catalyst formulation can include a noble metal and an admetal in a heterogeneous mixture or a solid solution with up to about 90% degree of alloying. The admetal can encourage the oxidation of catalyst poisons at room temperature and therefore reduces the exhaustion of the fuel cell.

### CROSS-REFERENCE TO RELATED APPLICATION

This application is related to and claims priority benefits from U.S. Provisional Patent Application Ser. No. 60/877,916 filed Dec. 29, 2006, entitled “Electrochemical Oxidation of Formic Acid Using a Noble Metal Based Catalyst With Oxophilic Metals,” which is hereby incorporated by reference in its entirety.

### FIELD OF THE INVENTION

The present technology relates generally to noble metal catalysts, including noble metals with admetals, for organic fuel cells. An admetal is a metal that modifies the properties of the noble metal catalyst and therefore also changes the catalyst properties. The admetal can have a function independent of the noble metal catalyst (that is, a bifunctional modifier), can modify the surface of the noble metal catalyst (that is, a third body modifier), or can modify the electronic structure of the noble metal catalyst (that is, an electronic modifier). More particularly, the technology relates to one or more noble metals that form a mixture with one or more noble or non-noble admetals. The mixture can range between a heterogeneous mixture and a solid solution with up to about 90% degree of alloying. The mixtures are suitable as catalysts in organic fuel cells.

### BACKGROUND OF THE INVENTION

Fuel cells are electrochemical cells in which the free energy change resulting from a fuel oxidation reaction is converted into electrical energy. Organic fuel cells are a useful alternative to hydrogen fuel cells in many applications, overcoming the difficulties of storing and handling hydrogen gas. In an organic fuel cell, an organic fuel such as methanol is oxidized to carbon dioxide at an anode, while air or oxygen is simultaneously reduced to water at a cathode. Organic/air fuel cells have the advantage of operating with a liquid organic fuel. Although methanol and other alcohols are typical fuels of choice for direct fuel cells, recent advances presented in U.S. Patent Application Publication Nos. 2003/0198852 and 2004/0115518 disclose formic acid fuel cells with high power densities and current output. Exemplary power densities of 150 mW/cm² and higher were achieved at low operating temperatures, and provided for compact fuel cells.

Applications for fuel cells include battery replacement; charging of mini- and microelectronics such as portable electronic devices; sensors such as gas detectors, seismic sensors, and infrared sensors; electromechanical devices; automotive engines and other transportation power generators; power plants, and many others.

Electrochemical fuel cells convert fuel and oxidant fluid streams to electricity and reaction product. Solid polymer electrochemical fuel cells generally employ a membrane electrode assembly (MEA) comprising a solid polymer electrolyte or ion-exchange membrane disposed between two porous electrically conductive electrode layers. An electrocatalyst is typically blended with polymer electrolyte and disposed at each membrane/electrode layer interface to induce the desired electrochemical reaction.

The electrode substrate typically comprises a sheet of porous, electrically conductive material, such as carbon fiber paper or carbon cloth. The layer of electrocatalyst is typically in the form of finely comminuted metal, such as platinum, palladium, or ruthenium, and is disposed on the surface of the electrode substrate at the interface with the membrane electrolyte in order to induce the desired electrochemical reaction. In a single cell, the electrodes are electrically coupled with or without additional metal sheet or mesh current collectors to provide a path for conducting electrons between the electrodes through an external load.

The fuel stream directed to the anode by a fuel flow field migrates through the porous anode and is oxidized at the anode electrocatalyst layer. The oxidant stream directed to the cathode by an oxidant flow field migrates through the porous cathode and is reduced at the cathode electrocatalyst layer.

Electrochemical fuel cells can employ gaseous fuels and oxidants, for example, those operating with molecular hydrogen as the fuel and oxygen in air or a carrier gas as the oxidant. In hydrogen fuel cells, hydrogen gas is oxidized and oxygen gas reduced to form water, with an electrical current produced as a byproduct of the oxidation reaction. A solid polymer membrane electrolyte layer can be employed to separate the hydrogen fuel from the oxygen. The anode and cathode are arranged on opposite faces of the membrane. Electron flow along the electrical connection between the anode and the cathode provides electrical power to load(s) interposed in the circuit with the electrical connection between the anode and the cathode. The anode and cathode reactions in hydrogen/oxygen fuel cells are shown in the following equations:

Anode reaction: H₂→2H⁺+2e⁻

Cathode reaction: ½O₂+2H⁺+2e⁻→H₂O

The catalyzed reaction at the anode produces hydrogen cations (protons) from the fuel supply. The ion-exchange membrane facilitates the migration of protons from the anode to the cathode. In addition to conducting protons, the membrane isolates the hydrogen-containing gaseous fuel stream from the oxygen-containing gaseous oxidant stream. At the cathode electrocatalyst layer, oxygen reacts with the protons that have crossed the membrane to form water as the reaction product. Hydrogen fuel cells are impractical for certain applications, however, because of difficulties related to storing and handling hydrogen gas.

Organic fuel cells may prove useful in many applications as an alternative to hydrogen fuel cells. In an organic fuel cell, an organic fuel such as methanol or formic acid is oxidized to carbon dioxide at an anode, while air or oxygen is simultaneously reduced to water at a cathode. One advantage over hydrogen fuel cells is that organic/air fuel cells can be operated with a liquid organic fuel. This diminishes or eliminates problems associated with hydrogen gas handling and storage. Some organic fuel cells require initial conversion of the organic fuel to hydrogen gas by a reformer. These are referred to as “indirect” fuel cells. A reformer increases cell size, cost, complexity, and start up time. Other types of organic fuel cells, called “direct,” operate without a reformer by directly oxidizing the organic fuel without conversion to hydrogen gas. To date, fuels employed in direct organic fuel cell development include methanol and other alcohols, as well as formic acid and other simple acids.

In direct liquid feed fuel cells, the reaction at the anode produces protons, as in the hydrogen/oxygen fuel cell described above. The protons (along with carbon dioxide) result from the oxidation of the organic fuel, such as formic acid. An electrocatalyst promotes the organic fuel oxidation at the anode. The organic fuel can alternatively be supplied to the anode as vapor, but it is common to supply the organic fuel to the anode as a liquid, preferably as an aqueous solution. The anode and cathode reactions in a direct formic acid fuel cell are shown in the following equations:

Anode reaction: HCOOH→2H⁺+CO₂+2e⁻

Cathode reaction: ½O₂+2H⁺+2e⁻→H₂O

Overall reaction: HCOOH+½O₂→CO₂+H₂O

The protons formed at the anode electrocatalyst migrate through the ion-exchange membrane from the anode to the cathode, and at the cathode electrocatalyst layer, the oxygen reacts with the protons and electrons to form water.

One obstacle to the widespread commercialization of direct organic fuel cell technology is the exhaustion of fuel cells, thus limiting the lifetime of the fuel cell. Fuel cells can become exhausted due to the accumulation of poisonous species, such as carbon monoxide (CO) and carbon monoxide-type intermediates, on the anode. Fuel cells can also become exhausted due to the formation of metal oxides on the cathode catalyst. For example, if a platinum catalyst is employed on the cathode, some of the platinum can be oxidized to form platinum oxides. The oxidation of the cathode catalyst decreases the activity of the catalyst and therefore decreases the effectiveness of the fuel cell as a power source. In addition, a fuel cell can become exhausted due to membrane dry-out.

Various parties have investigated the stability of noble metal catalysts in the electrooxidation of formic acid. For example, A. Capon and R. Parsons investigated palladium, platinum, Rh, Ir, and Au in the electrooxidation of formic acid and concluded that platinum catalysts are more stable than palladium catalysts, but palladium catalysts are more active than platinum catalysts. See J. Electroanal. Chem., 44 (1973) 239; J. Electroanal. Chem., 45 (1973) 205. Wieckowski et al. examined the reaction mechanism on pure platinum, pure palladium, and platinum-palladium catalysts and reached the same conclusion as Capon and Parsons. J. Physical Chem. B. 103, 9700 (1999).

In WO 2005/048379, unsupported palladium is employed as a catalyst for formic acid electrooxidation. These catalysts give higher anode currents in direct formic acid fuel cells but exhibit limited stability.

If a catalyst can exhibit improved activity to platinum and demonstrate improved stability to palladium over time, commercialization is possible. As outlined below, others have tried to solve this problem using decorated platinum and palladium structures or ordered structures consisting of near perfect alloys.

The Adzic group investigated the effect of foreign metal monolayers such as Pb, Cd, Bi, Ti, Ag, and Cu, on platinum and palladium catalysts in the electrooxidation of formic acid. See J. Electroanal. Chem., 92 (1978) 31-43; J. Electroanal. Chem., 150 (1983) 79-88. DiSalvo and Abruna have disclosed the effect of platinum alloyed with Bi, Pb, In, Mn, Ru, Sn and Sb and palladium alloyed with Bi, Sb and Ge in highly ordered catalyst structures containing less than 10 defects per 100 atoms. See U.S. Patent Application Publication No. 2004/0126267.

U.S. Patent Application Publication No. 2003/0198852 discloses an anode catalyst containing nanoparticles of noble metals, or Ru, Co, Fe, Ni, and/or Mn having a coating of platinum, palladium, or ruthenium on their surface.

United Kingdom patent GB 2422048 discloses palladium decorated foils of titanium, zirconium, vanadium, niobium, tantalum, chromium, molybdenum, tungsten and gold. It also discloses a co-reduction of palladium with a metal such as gold in a 50:1 ratio and that this modified palladium catalyst can be supported on carbon.

Energy-consuming regeneration procedures can recover the fuel cell performance. This regeneration, however, requires an input of power to the fuel cell and can also damage fuel cell components. Regeneration can also increase the number, cost, and complexity of the fuel cell components.

In direct liquid feed fuel cells, removal of the catalyst poison can be accomplished by reducing the catalyst poison to methane or by oxidizing the catalyst poison to carbon dioxide. Oxidizing the catalyst poison is advantageous because it does not consume hydrogen.

There is thus a desire for a catalyst formulation that is well-suited to liquid fuels such as formic acid and that reduces the poisoning of the catalyst and the need for regeneration while maintaining the overall performance of the fuel cell.

### SUMMARY OF THE INVENTION

One or more shortcomings of conventional catalyst formulations for a liquid feed fuel cell are addressed by the present catalyst formulations. In one embodiment, a catalyst comprises a noble metal with an admetal, where the noble metal and the admetal form a heterogeneous mixture or a solid solution with up to about 90% degree of alloying. It is possible that the admetal changes the capacity of the noble metal to adsorb organic molecules, such as formic acid, making pure alloys less desirable. In addition, decorated structures can show limited stability with the admetals leaching from the surface over time. The present approach represents a compromise in the extent and method of atomic mixing. Suitable noble metals include palladium, platinum, rhodium, gold, iridium and osmium, while suitable admetals include tin, ruthenium, molybdenum, rhenium, vanadium, bismuth, lead, gold, antimony, alloys thereof, oxides thereof, or combinations thereof. The result is higher activity than platinum and long term stability better than palladium, hence it will require reduced regeneration depending on the formulation.

In another embodiment, a direct organic liquid feed fuel cell comprises:
(a) an anode;
(b) a cathode;
(c) a liquid organic fuel; and
(d) an anode catalyst, wherein the anode catalyst comprises a noble metal and an admetal, and where the noble metal and the admetal form a heterogeneous mixture or a solid solution with up to about 90% degree of alloying.

In a preferred embodiment, the organic fuel is formic acid, preferably as a liquid in an aqueous solution.

In a further embodiment, a method of reducing catalyst poisoning in a direct organic liquid feed fuel cell comprises preparing a catalyst comprising a noble metal and an admetal in a heterogeneous mixture or a solid solution with up to about 90% degree of alloying.

In a further embodiment, a method of preparing an anode catalyst for a direct liquid feel fuel cell comprises admixing a noble metal and an admetal and depositing the admixture with a solid polymer electrolyte such as Nafion® on an electrically conductive sheet material to form an anode.

### BRIEF DESCRIPTION OF THE DRAWINGS

FIG. 1 is a cyclic voltammogram of platinum and tin catalyst formulations.

FIG. 2 is a cyclic voltammogram of palladium and tin catalyst formulations.

FIG. 3 is an x-ray diffraction spectrum showing the degree of alloying platinum and tin catalyst formulations.

FIG. 4 is a chronopotentiometric plot showing the anode stability of platinum and tin catalysts in a single cell test fixture.

FIG. 5 is a chronopotentiometric plot showing the anode activity and stability of platinum and platinum and tin catalysts in a single cell test fixture.

FIG. 6 is a chronopotentiometric plot showing the anode activity and stability of platinum, platinum-ruthenium, platinum-rhenium, and platinum-molybdenum catalysts in a single cell test fixture.

FIG. 7 is a chronopotentiometric plot showing the anode activity and stability of palladium, palladium and gold, and palladium and bismuth catalysts.

FIG. 8 is a chronopotentiometric plot showing the anode activity and stability of platinum, palladium and tin ternary catalysts in a single cell test fixture.

FIG. 9 is a chronopotentiometric plot showing the activity and stability of platinum and tin supported on carbon (Vulcan XC72) as well as a heterogeneous mixture of platinum catalyst supported on carbon and tin (IV) oxide in a single cell test fixture.

### DETAILED DESCRIPTION OF PREFERRED EMBODIMENT(S)

A catalyst formulation is provided as a catalyst for organic liquid feed fuel cells where the catalyst formulation reduces catalyst poisoning and exhaustion of the fuel cell while maintaining catalyst stability and activity. These catalysts are also suitable for employment in an acidic environment, such as with fuels like formic acid.

Fuel cells generally have an anode and a cathode disposed on either side of an electrolyte. The anode and cathode generally comprise an electrocatalyst, such as platinum, palladium, platinum-ruthenium alloys, or other noble metals or metal alloys. The electrolyte usually comprises a proton exchange membrane (PEM), typically a perfluorosulfonic acid polymer membrane, of which Nafion® is a commercial brand. At the anode, fuel is oxidized at the electrocatalyst to produce protons and electrons. The protons migrate through the proton exchange membrane to the cathode. At the cathode, the oxidant reacts with the protons. The electrons travel from the anode to the cathode through an external circuit, producing an electrical current.

Liquid feed electrochemical fuel cells can operate using various liquid reactants. For example, the fuel stream can be methanol in a direct methanol fuel cell, or formic acid fuel in a direct formic acid fuel cell (DFAFC). The oxidant can be substantially pure oxygen or a dilute stream such as air, containing oxygen.

The embodiments will be described in detail with respect to DFAFC, with applicability to other liquid fuel cells such as methanol.

As described above, the present technology relates to a catalyst for a direct liquid feed fuel cell where the catalyst includes a noble metal and an admetal. The role of the admetal in the present technology can be a bifunctional, third body or electronic type of catalytic mechanism. In a bifunctional type mechanism, the noble metal catalyst provides active sites for electrooxidation of the small organic molecule and the admetal provides sites for water dissociation for utilization in oxidizing the poison intermediates. In a third body type mechanism, the admetal modifies the surface of the noble metal catalyst making it more difficult for poisoning species to adsorb. In the electronic type mechanism, the admetal modifies the crystalline structure of the noble metal and thus its capacity to bond with and adsorb poisoning species. These three mechanisms are not mutually exclusive. For example, some electronic effects will be evident in the bifunctional and third body mechanisms. When the capacity of the catalyst to adsorb poisons is changed, the capacity of the catalyst to adsorb fuel (for example, formic acid or methanol) can also be changed. Thus, the activity of the catalyst can be greatest when the degree of alloying is lower, balancing the ability of a catalyst to adsorb fuel and desorb poisons.

In general, poison intermediates such as carbon monoxide (CO) that are adsorbed on a noble metal catalyst surface can be oxidized from the noble metal surface through a Langmuir-Hinshelwood type reaction with neighboring hydroxide (OH) species electroadsorbed from water. The adsorbed hydroxide oxidizes the poison intermediate (usually carbon monoxide, or CO) to carbon dioxide, thereby cleaning the electrode surface and recovering catalyst performance.

In the bifunctional mechanism, oxophilic metals such as tin, ruthenium, rhenium, molybdenum, and vanadium encourage the dissociation of water and the adsorption of hydroxide at lower potentials than do noble metals. Consequently, the oxidation of catalyst poisons is completed at lower anodic potentials.

Poison intermediates such as carbon monoxide (CO) that are adsorbed on the noble metal catalyst surface can also be more easily oxidized by modifying the surface of the catalyst with an inert metal. In a third body type mechanism, admetals that are not catalytically active in the oxidation of formic acid (that is, inert) such as antimony, bismuth, gold or lead can block neighboring noble metal catalyst sites making it difficult for poison intermediates to adsorb. The inert metal can also create concentration effects with the adsorbed poison by segregating the noble metal catalyst surface.

Poison intermediates such as carbon monoxide (CO) that are adsorbed on the noble metal catalyst surface can also be more easily oxidized and desorbed by alloying the noble metal catalyst with an admetal that modifies the crystalline structure of the noble metal catalyst. Oxophilic metals and inert metals can also modify the crystalline structure of the noble metal catalyst. For example, ruthenium will cause a compression in the lattice parameter of the platinum crystalline structure and tin will cause an expansion in the lattice parameter of the platinum crystalline structure.

The admetal modification mechanisms are not mutually exclusive. It is possible that one or more mechanisms will work simultaneously for a given formulation. It is also possible that the modifier will change the capacity of the noble metal catalyst to adsorb fuel and that a lower degree of alloying of the noble metal(s) and admetal(s) will be desirable.

Suitable noble metals that can be employed as catalysts include platinum, palladium, platinum-ruthenium alloys, rhodium, gold, iridium, osmium, or other noble metals or metal alloys. Suitable admetals that can be employed as catalysts include tin, ruthenium, rhenium, molybdenum, vanadium, bismuth, lead, gold, antimony, alloys thereof, oxides thereof, and combinations thereof. Nanoparticles or other structures of these metals are suitable catalysts. One or more noble metals can also be combined with one or more admetals, creating binary or ternary catalysts. For example, platinum, palladium, and tin can form a ternary catalyst for an organic fuel cell.

The catalyst can be supported on different conductive, semiconductive, or insulator supports including carbon, tin oxide (SnO₂), ceria (CeO₂), titania (TiO₂) and zirconia (ZrO₂). Where a carbon substrate is the catalyst support, the carbon substrate can be porous carbon, such as Vulcan XC72, activated carbon, or carbon nanotubes. In addition, the noble metal can be on a support and form a heterogeneous mixture with one or more supported or unsupported admetals, or the noble metal and admetal mixture or alloy can be on a support.

Other admetals can also be employed with other noble metal catalysts in the present technology. Alloys or other combinations of admetals can be employed with noble metal catalysts in the present technology.

Nanoparticles of partial or incomplete noble metal and admetal alloys can be prepared by the reduction of metal salt precursors. These metals salts can be chlorides, nitrates, acetates or others and combinations of these salts. The technique developed by Dan Goia's group employs a polyol solvent and comprises a one or two step reduction process in the presence of a reducing agent. See D. V. Goia, J. Mater Chem, 14, 451-458, 2004; D. V. Goia, E. Matijevic New. J. Chem. 1203-1215, 1998. D. V. Goia, U.S. Patent Application Publication No. 2006/0094597. The reducing agent can be sodium borohydride, hydrazine, hydroxylamine, etc., or the solvent itself. The polyol solvents that can be employed include 1,2-ethylene glycol (EG), diethylene glycol (DEG), 1,2-propylene glycol (PG), 1,3-propylene glycol, glycerol, etc., as well as their mixtures. Optionally, polysaccharides and/or polymers can be added as stabilizers to produce protective colloids and to prevent particle agglomeration. This method can also be employed to prepare supported catalysts. The support can be carbonaceous materials and/or inorganic oxides.

In one example, a Pt/Sn catalyst is prepared unsupported in a 75:25 atomic ratio. 0.8829 g hexachloroplatinic acid hexahydrate (H₂PtCl₆.6H₂O), 0.1077 g tin (II) chloride (SnCl₂), and 0.4 g of protective colloid stabilizer (previously dissolved in 3 g of deionized water under mixing) are dissolved in 180 mL of 1,2-propylene glycol under a nitrogen blanket. The mixture is allowed to stir for 30 minutes. A saturated solution containing ten (10) times excess sodium borohydride (NaBH₄) in water is prepared by mixing 4.299 g of NaBH₄ in 25 mL of water. The borohydride solution is added to the polyol mixture under a nitrogen blanket and constant stirring. The mixture is subsequently allowed to age for 1 hour. After 1 hour the pH of the solution is adjusted to 1 using dilute (1.5 M) hydrochloric acid. The solution is heated to 60° C. and held at this temperature for 16 hours to hydrolyze the protective shell. The resultant Pt/Sn is washed in deionized water and dried.

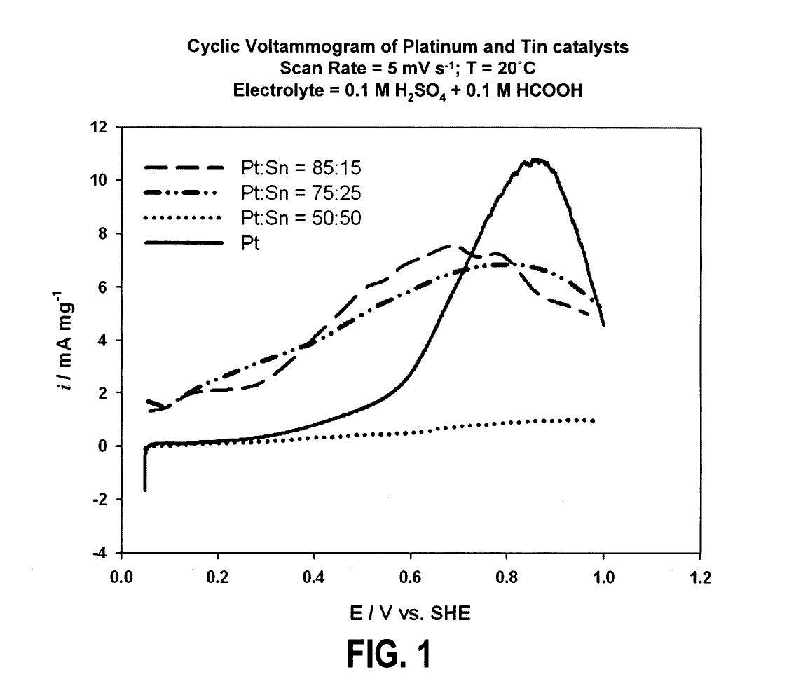

FIG. 1 is a cyclic voltammogram showing the activity of platinum and platinum and tin catalysts over a range of potentials. One platinum and three platinum and tin catalysts were prepared. Each of the catalysts was synthesized using the borohydride reduction of metal salt precursors in a polyol medium as described above. Each of the three platinum and tin catalysts had different atomic ratios of platinum to tin (Pt:Sn). The atomic ratios of platinum to tin were 85:15, 75:25, and 50:50 Pt:Sn. Each electrode was fabricated using a direct paint technique to apply a mixture of catalyst and Nafion® on a gold substrate.

A single cyclic voltammogram in 0.1 M formic acid and 0.1 M sulfuric acid was performed at a scan rate of 5 mV/s. Measurements were conducted using a conventional three-electrode cell powered by a Keithley 2400 potentiostat. Platinum served as the counter electrode and Ag/AgCl in 3 M KCl as the reference electrode.

FIG. 1 shows that with the exception of the 50:50 Pt:Sn ratio, the onset potential for formic acid electrooxidation on the platinum electrode occurs at a more positive potential than for the platinum and tin electrodes. The onset potential for formic acid electrooxidation on the platinum electrode occurs at about 0.4 V vs. SHE and the onset potential for formic acid electrooxidation on the platinum and tin electrodes occurs at less than about 0.1 V vs. SHE. Also, electrooxidation of the adsorbed poisoning CO occurs at a more positive potential on the platinum electrode than for the platinum and tin electrodes. Electrooxidation of the adsorbed poisoning CO occurs at about 0.85 V vs. SHE (Standard Hydrogen Electrode) on the platinum electrode. Electrooxidation of the adsorbed poisoning CO occurs at about 0.7 V vs. SHE on the platinum and tin electrodes.

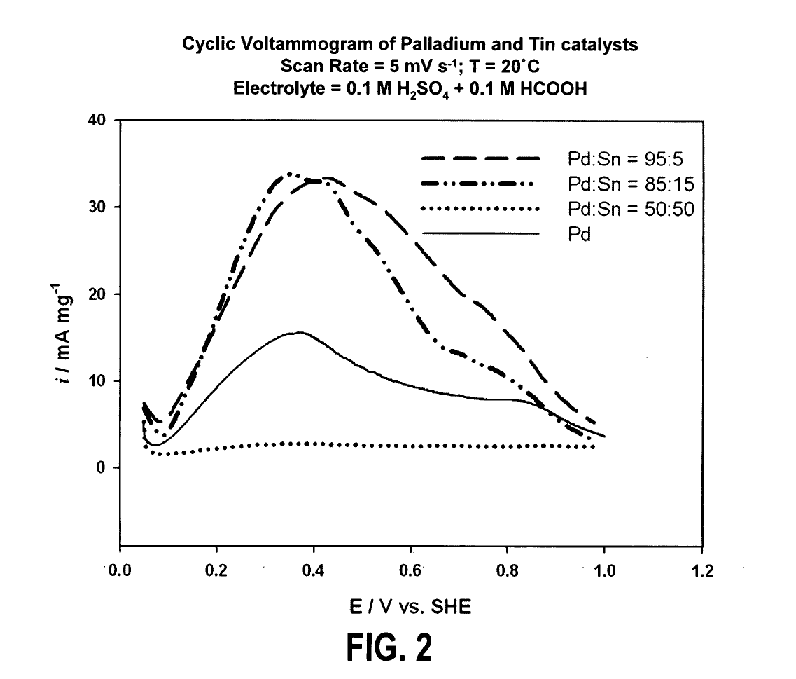

FIG. 2 is a cyclic voltammogram showing the activity of palladium and tin catalysts over a range of potentials. Three palladium and tin catalysts were prepared. Each of the three palladium and tin catalysts had a different atomic ratio of palladium to tin (Pd:Sn). The atomic ratios of palladium to tin in the three catalysts were 95:5, 85:15, and 50:50 (Pd:Sn). These catalyst formulations were synthesized using the borohydride reduction of metal salt precursors in a polyol medium as described above. Each electrode was fabricated using a direct paint technique to apply a mixture of catalyst and recast 5% by weight Nafion® on a gold substrate.

A single cyclic voltammogram in 0.1 M formic acid and 0.1 M sulfuric acid was performed at a scan rate of 5 mV/s. Measurements were conducted using a conventional three-electrode cell powered by a Keithley 2400 potentiostat. Platinum served as the counter electrode and Ag/AgCl in 3 M KCl as the reference electrode.

FIG. 2 shows that, with the exception of the 50:50 Pd:Sn catalyst, the palladium and tin catalysts also lower the onset potential for formic acid electrooxidation as compared to palladium alone.

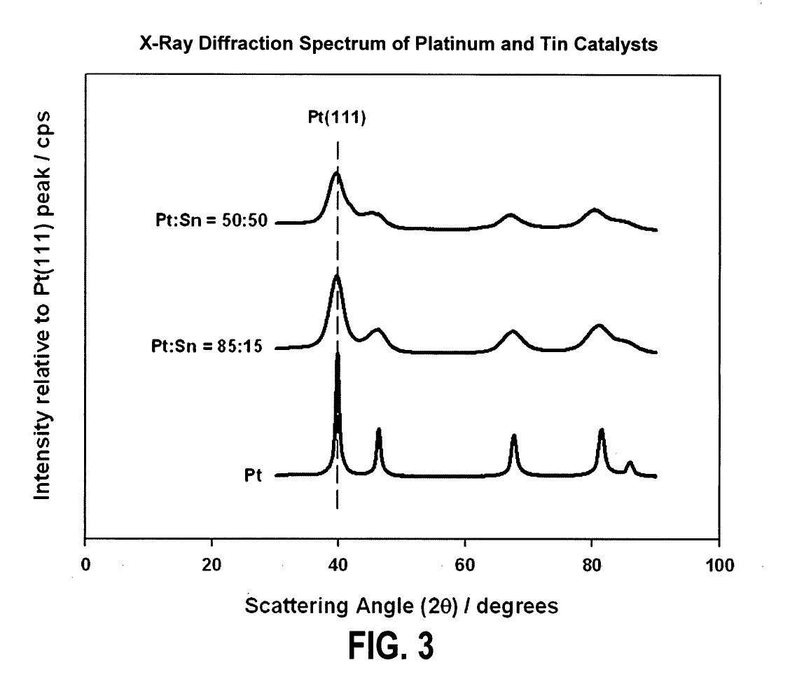

FIG. 3 shows x-ray diffraction (XRD) spectra from the Pt/Sn alloy crystalline structure collected using a Rigaku D/Max-Rapid Diffractometer with Cu—Kα radiation. Line profile analysis was employed to obtain structural information from the Pt/Sn catalysts. Imperfections in the structure of the alloy crystals cause broadening of the diffraction line profiles and the degree of platinum/tin alloying is approximated by XRD peak shifting. This has been employed to monitor the relative composition of the solid solution. The shift in peak position is consistent with Vegard's Law that states that the lattice parameters of a binary alloy are directly proportional to the atomic percent of the solid solution. FIG. 3 shows that at least some degree of alloying occurs in the platinum and tin catalysts.

TABLE 1, below, shows the degree of Pt/Sn alloying for the Pt/Sn catalysts shown in FIG. 3. The degree of alloying was calculated using XRD parameters established by Colmati, Antolini and Gonzalez in ECS Transactions 3-2 (2006), pages 1307-1316.

TABLE 1

| | Lattice Parameter, a₀ | Degree of Alloying |
|---|---|---|
| Catalyst | (nm) | (%) |
| Pt:Sn = 85:15 | 0.3932 | 43 |
| Pt:Sn = 50:50 | 0.3929 | 12 |
| Pt | 0.3908 | — |

TABLE 1 and FIG. 1 demonstrate that the noble metal and admetal can be partially alloyed.

TABLE 2, below, shows the relative amount of tin and tin (IV) oxide on the surface of the catalyst for Pt/Sn catalysts as determined by X-ray photoelectron spectroscopy (XPS).

TABLE 2

| | Surface Composition |
|---|---|
| Catalyst | Pt:Sn:SnO₂ (%) |
| Pt:Sn = 85:15 | 73:10:17 |
| Pt:Sn = 50:50 | 47:7:47 |

TABLE 2 and FIG. 1 demonstrate that the admetal can be in both the oxidized and reduced form.

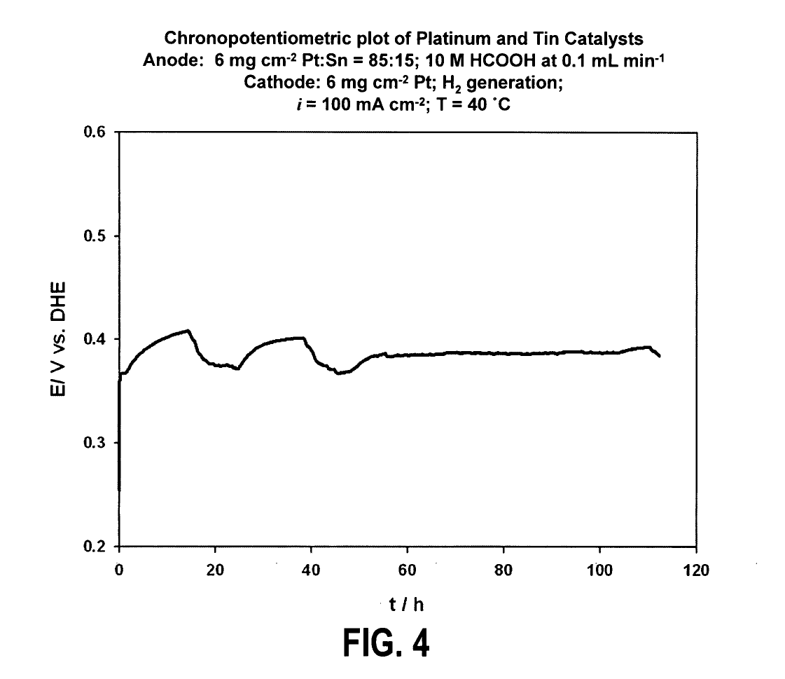

FIG. 4 shows the stability of platinum and tin catalysts in a single-cell test fixture. An active cell was fitted with a membrane electrode assembly (MEA) with an active area of 5.2 cm² sandwiched between two graphite blocks with simple serpentine channels for formic acid (anode) and hydrogen (cathode) flow. The cathode ink consisted of platinum black (HiSPEC 1000, Johnson Matthey Inc.) and recast Nafion® direct painted on a Nafion® 117 membrane, with Elat® (A1, E-TEK) as a gas diffusion layer. The anode was also prepared by a direct paint technique of the catalyst layer. The catalyst formulation was synthesized using the borohydride reduction of metal salt precursors in a polyol medium as described above. Approximately 6 mg catalyst was applied per cm² on the anode side of the membrane, and a carbon cloth (B-1/B, E-TEK) diffusion layer was employed.

The propensity for formic acid oxidation on platinum and tin catalysts was examined in the active cell by chronopotentiometry. The active cell was operated in “driven mode” with formic acid being oxidized at the anode and hydrogen evolving at the cathode, acting as a counter/quasi-reference electrode (Dynamic Hydrogen Electrode, or DHE). In particular, anode polarizations (FIG. 4) for 10 M formic acid oxidation on platinum and tin catalysts have been pursued for about 120 hours with an applied load of 100 mA/cm². FIG. 4 demonstrates that the platinum and tin catalysts exhibit platinum like stability.

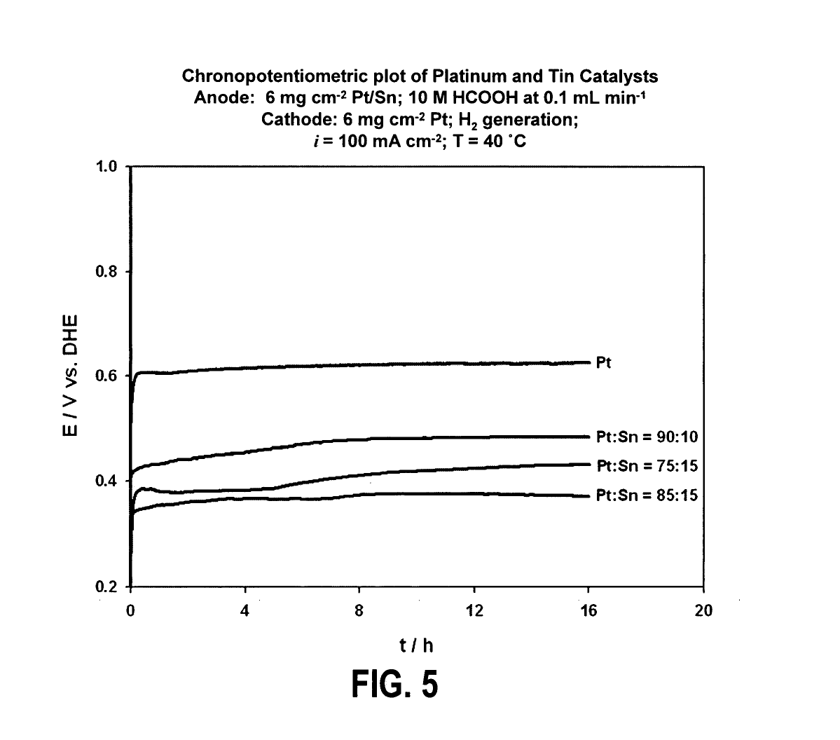

FIG. 5 shows the anode activity and stability of platinum and tin catalysts in a single cell test fixture operating in “driven mode.” These catalyst formulations were synthesized using the borohydride reduction of metal salt precursors in a polyol medium as described above. In particular, anode polarizations for 10 M formic acid oxidation on platinum and palladium and tin catalysts have been pursued for about 16 hours with an applied load of 100 mA/cm². FIG. 5 demonstrates that platinum and tin catalysts operate with a lower anodic overpotential than platinum catalysts and exhibit stability.

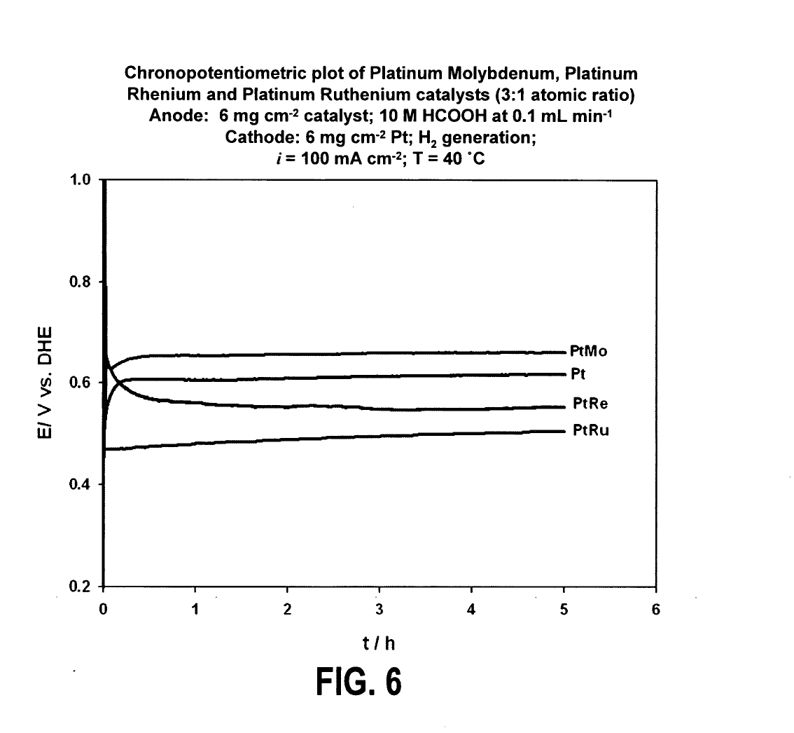

FIG. 6 shows the stability of platinum, platinum-ruthenium, platinum-rhenium, and platinum-molybdenum catalysts in a single cell test fixture operating in “driven mode.” These catalyst formulations were synthesized using the borohydride reduction of metal salt precursors in a polyol medium as described above. In particular, anode polarizations for 10 M formic acid oxidation on the catalysts have been pursued for about 5 hours with an applied load of 100 mA/cm². FIG. 6 demonstrates that the platinum and admetal catalysts show similar stability to platinum. Also, in cases other than the platinum and molybdenum catalyst, the platinum and admetal catalysts operate with a lower anodic overpotential than the platinum catalyst.

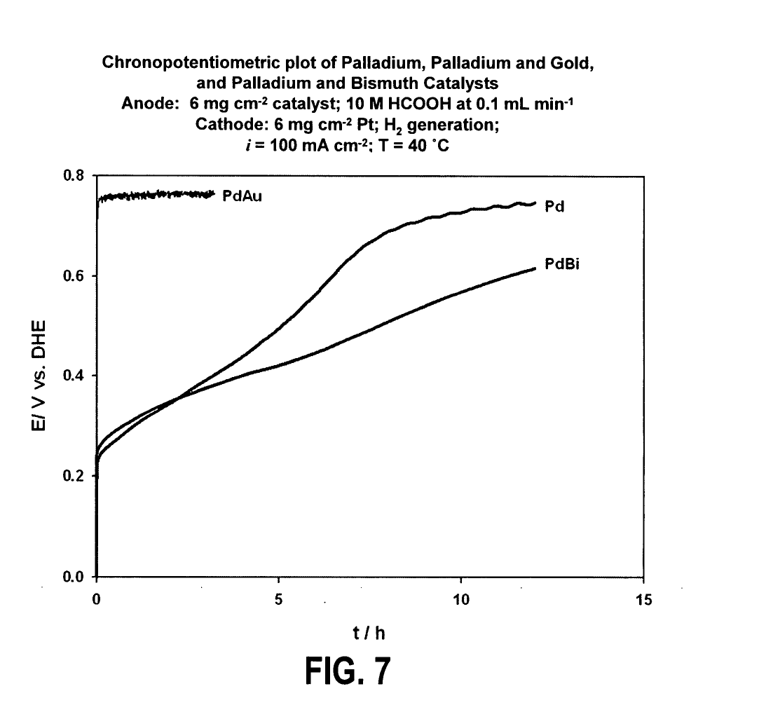

FIG. 7 shows the anode activity and stability of palladium, palladium and gold, and palladium and bismuth catalysts in a single cell test fixture operating in “driven mode.” These catalyst formulations were synthesized using the borohydride reduction of metal salt precursors in a polyol medium as described above. In particular, anode polarizations for 10 M formic acid oxidation on palladium, palladium and gold, and palladium and bismuth catalysts have been pursued for about 3 to 12 hours with an applied load of 100 mA/cm². FIG. 7 demonstrates that palladium and bismuth catalyst operates with a lower anodic overpotential than the palladium catalyst and that the palladium and gold catalyst is more stable than the palladium catalyst.

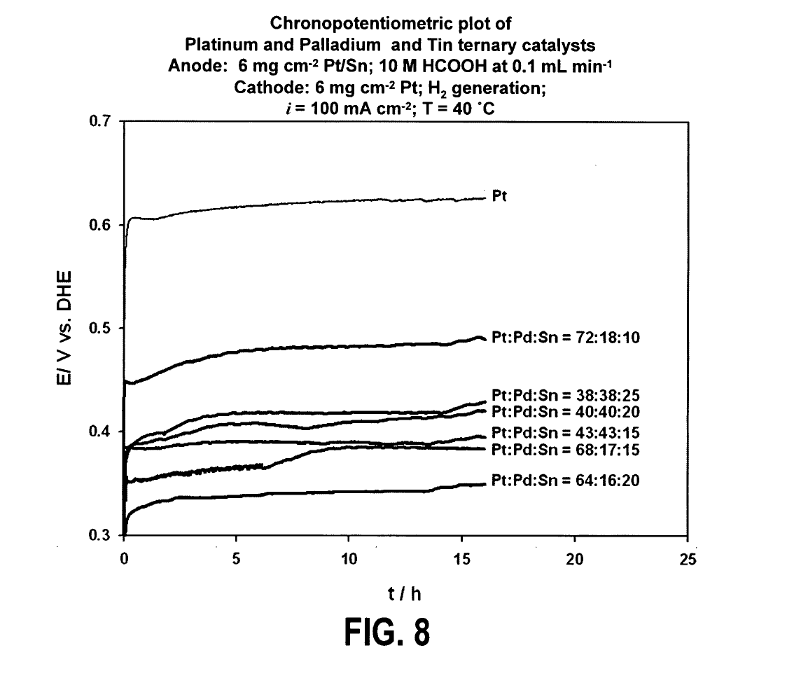

FIG. 8 shows the anode activity and stability of platinum and platinum, palladium, and tin ternary catalysts in a single cell test fixture operating in “driven mode.” These catalyst formulations were synthesized using the borohydride reduction of metal salt precursors in a polyol medium as described above. In particular, anode polarizations for 10 M formic acid oxidation on platinum and palladium and tin catalysts have been pursued for about 16 hours with an applied load of 100 mA/cm². FIG. 8 demonstrates that the platinum, palladium, and tin ternary catalysts operate with lower anodic overpotential than the platinum catalyst and exhibit good stability.

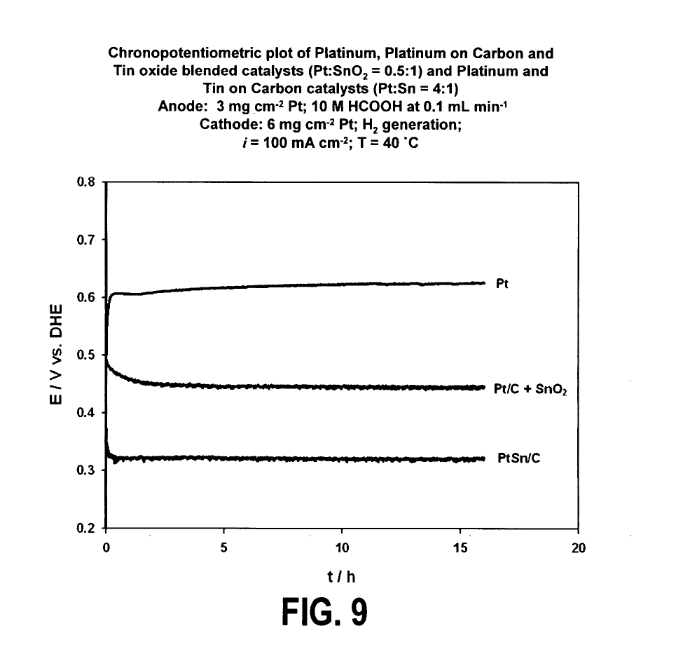

FIG. 9 shows the anode activity and stability of an unsupported platinum black, platinum and tin supported on carbon and a heterogeneous mixture of platinum supported on carbon with tin (IV) oxide blended catalysts in a single cell test fixture operating in “driven mode.” The platinum and tin on carbon (PtSn/C) catalyst formulation was synthesized using the borohydride reduction of metal salt precursors mixed with Vulcan XC72 carbon support powder in a polyol medium as described above. The platinum on carbon (Pt/C) and tin (IV) oxide (NanoTek® powder, Alfa Aesar) blended catalyst was prepared by physically mixing the two powders. In particular, anode polarizations for 10 M formic acid oxidation the catalysts have been pursued for about 16 hours with an applied load of 100 mA/cm². FIG. 9 demonstrates that both the platinum and tin on carbon as well as the heterogeneous mixture of platinum supported on carbon and tin (IV) oxide catalysts have comparable performance and stability to the platinum and tin partially alloyed catalysts and operates at a lower anodic potential than platinum catalysts.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A catalyst for a direct organic liquid fuel cell comprising a noble metal and an admetal, wherein the noble metal and the admetal form a heterogeneous mixture or a solid solution with up to about 90% degree of alloying.

2. The catalyst of claim 1, wherein the noble metal is at least one of palladium, platinum, gold, rhodium, iridium and osmium.

3. The catalyst of claim 1, wherein the admetal is at least one of tin, ruthenium, molybdenum, rhenium, vanadium, bismuth, lead, gold, antimony, alloys thereof, oxides thereof and combinations thereof.

4. The catalyst of claim 1 further comprising a third metal, wherein the third metal comprises a noble metal or an admetal.

5. The catalyst of claim 1 wherein the metals are supported on a porous carbon.

6. A direct organic liquid feed fuel cell comprising:
(a) an anode;
(b) a cathode;
(c) a liquid organic fuel; and
(d) an anode catalyst, comprising a noble metal and an admetal, wherein the noble metal and the admetal form a heterogeneous mixture or a solid solution with up to about 90% degree of alloying.

7. The fuel cell of claim 6 wherein the noble metal is at least one of palladium, platinum, gold, rhodium, iridium and osmium.

8. The fuel cell of claim 6 wherein the admetal is at least one of tin, ruthenium, molybdenum, rhenium, vanadium, bismuth, lead, gold, antimony, alloys thereof, oxides thereof and combinations thereof.

9. The fuel cell of claim 6 wherein the anode catalyst further comprises a third metal, wherein the third metal comprises a noble metal or an admetal.

10. The fuel cell of claim 7 wherein the anode catalyst is supported on a carbon substrate.

11. The fuel cell of claim 6 wherein the anode catalyst comprises a mixture of a noble metal supported on a carbon substrate (or metal oxide) and a supported or unsupported admetal in the reduced or oxidized form.

12. The fuel cell of claim 6 wherein the liquid organic fuel comprises formic acid.

13. A method of reducing catalyst poisoning in a direct organic liquid feed fuel cell comprising preparing a catalyst comprising a noble metal and an admetal, wherein the noble metal and the admetal form a heterogeneous mixture or a solid solution with up to about 90% degree of alloying.

14. A method of preparing an anode catalyst for a direct liquid feed fuel cell comprising:
(a) admixing a noble metal and an admetal to form a heterogenous mixture or a solid solution with up to about 90% degree of alloying; and
(b) depositing the admixture on an electrically conductive sheet material to form an anode.
